(19) United States
(12) Patent Application Publication
(10) Pub. No.: US 2006/0048305 A1
(43) Pub. Date: Mar. 9, 2006

(54) Combination hand tool

(76) Inventors: Matteo Giordano III, Toms River, NJ (US); George J. Kennedy, Paramus, NJ (US); Luis Alberto Bermudez, Brooklyn, NY (US)

Correspondence Address: JAMES RAY & ASSOCIATES, 2640 PITCAIRN ROAD, MONROEVILLE, PA, 15146, US

(21) Appl. No.: 11/103,895

(22) Filed: Apr. 12, 2005

Related U.S. Application Data
(60) Provisional application No. 60/608,026, filed on Sep. 8, 2004.

(51) Int. Cl. B25D 1/04

(52) U.S. Cl. 7/143; 7/160; 7/144

(57) ABSTRACT

A combination hand tool includes an elongated member forming a handle which has a first and an axially opposed second end. A tool head is rigidly attached to the first end of the elongated member. A sleeve like member is rigidly attached to the second end of the elongated member and has a collapsible open end for retaining an accessory working element which is secured with a rotatatably disposed nut. A plurality of tabs is integrally formed on the outer surface of the elongated member for frictionally retaining a plurality of working elements. An aperture is provided for housing a measuring tape assembly. At least one bubble-type level is disposed within the elongated member for level measurements and a pair of surfaces are provided for establishing a reference plane for such level measurements.

### CROSS-REFERENCE TO RELATED APPLICATIONS

This application is related to and claims priority from U.S. Provisional Patent Application Ser. No. 60/608,026 filed on Sep. 8, 2004.

### FIELD OF THE INVENTION

The present invention relates, in general, to hand tools for use in various applications and, more particularly, this invention relates to a combination hand tool in the form of a hammer having a plurality of work engaging tool elements removably mounted therein.

### BACKGROUND OF THE INVENTION

As is generally well known hand tools are utilized to perform a specific function and therefore a person must purchase a variety of such hand tools and a carrying container in order to perform a variety of individual projects. Such requirement to carry a variety of individual tools may be costly, space demanding and cumbersome for some individuals, particularly those who are novices in do-it-yourself projects, who use tools on an infrequent basis or who are limited with space to store tools. Yet, tools such as hammers, screwdrivers, wrenches and a measuring tape are generally sufficient to perform a variety of projects, particularly in the household or office environment.

Attempts have been made to provide tools which are suitable for multiple uses. One example is U.S. Pat. No. 6,122,788 issued to Bulcock which teaches a hammer with a handle formed so that its volume is used as compartments for storage of supplies and a measuring tape is incorporated into a bottom of the handle and is extendable therefrom for use. Such handle construction increases the cost of the tool due to its complexity, results in difficulties of using such measuring tape associated with the need to use the hammer as well and increases the cost of the measuring tape replacement.

Another example is U.S. Pat. No. 1,109,507 issued to Bostock which shows a hammer with a plurality of sockets disposed within the handle for storing various small tool bits.

In U.S. Pat. No. 102,677 issued to Gregory, a single chamber is bored within the handle for storage of work engaging tool elements such as tool bits and is adapted with a cover for containing such tool bits within the chamber.

The handle construction in U.S. Pat. No. 1,109,507 and U.S. Pat. No. 102,677 increases complexity and cost of the tool and requires an extra effort on the part of the user to gain access to various tool bits.

Therefore, there is a need for an improved multifunctional combination tool which overcomes disadvantages of the presently used combination tools.

### SUMMARY OF THE INVENTION

The invention provides a combination hand tool which includes an elongated member having a predetermined shape forming a handle which has a first and an axially opposed second end. A tool head has a first portion for is rigid attachment to the first end of the elongated member. The tool head also has a second portion extending from the first portion and terminated with a first flat end and a third portion extending from the first portion in the opposite direction and configured as a claw thus configuring the combination hand tool in a form of a hammer. A sleeve like member is rigidly attached to the second end of the elongated member and has a collapsible open end for retaining an accessory working element which is secured with a rotatatably disposed nut. Rotation of the nut in one direction collapses the open end and secures the working tool element while rotation of the nut in the opposed direction enables removal of the working element. A plurality of tabs are integrally formed on the outer surface of the elongated member for frictionally retaining a plurality of working tool elements. Each working tool element is provided with a predetermined working portion configuration for performing a specific function. An aperture is provided within the elongated member intermediate its ends for removeably housing a measuring tape assembly. A first tab, pivotally attached to the elongated member adjacent one end of the aperture, may be provided for partially moving the measuring tape assembly from engagement with the aperture. A second tab, rigidly disposed within the aperture, may be provided for frictionally retaining such measuring tape assembly. At least one bubble-type level is disposed within the elongated member for level measurements and a pair of surfaces are provided for establishing a reference plane for such level measurements.

### OBJECTS OF THE INVENTION

It is, therefore, one of the primary objects of the present invention to provide a combination hand tool.

Another object of the present invention is to provide a combination hand tool in the form of a hammer.

Yet another object of the present invention is to provide a combination hand tool in the form of a hammer which is capable of retaining a predetermined plurality of work engaging tool elements.

A further object of the present invention is to provide a combination hand tool in the form of a hammer which provides for ease of access to a plurality of work engaging tool elements.

Yet a further object of the present invention is to provide a combination hand tool in the form of a hammer which incorporates a measuring tape and provides for ease of use of such measuring tape.

An additional object of the present invention is to provide a combination hand tool in the form of a hammer which incorporates devices for level measurements and reference surfaces to perform such level measurements.

Yet another object of the present invention is to provide a combination hand tool in the form of a hammer which is economical to manufacture.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a plan view of a combination hand tool of a presently preferred embodiment of the present invention;

FIG. 2 is a side view of the combination hand tool illustrated in FIG. 1;

FIG. 3 is an end view of the handle portion of the combination hand tool of the present invention particularly showing an alternative embodiment of the tool attachment;

FIGS. 4a-4c show accessory working elements suitable for use with the combination hand tool of the present invention; and

FIG. 5 shows a measuring tape assembly suitable for use with the combination hand tool of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

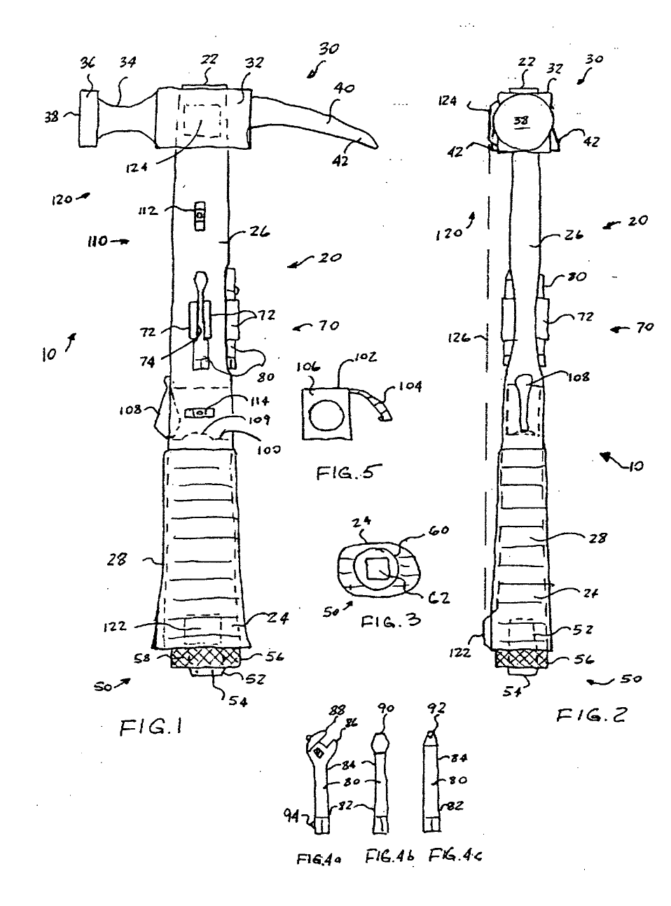

Reference is now made, to FIGS. 1-5, wherein there is shown a combination hand tool, generally designated 10, of the present invention comprising an elongated member, generally designated 20, having a first predetermined shape and having a first end 22, an axially opposed second end 24 and a generally solid core 26. Such elongated member 20 may be manufactured from materials including but not limited to wood, metal and engineered polymers. The preferred material of such elongated member is an engineered polymer, such as fiberglass, and a preferred manufacturing process is molding.

A predetermined length of the elongated member 20 adjacent a second end 24 may be adapted to receive means 28 for gripping such elongated member 20 during use. The preferred material of the gripping means 28 is an elastomer.

There is a tool head, generally designated 30, having a first member 32 adapted for rigidly mounting to first end 22 of the elongated member 20, a second member 34 outwardly extending from such first member 32 in one direction and being generally terminated with a striking end 36 which preferably has a flat surface 38, and a third member 40 outwardly extending from such member 32 in a direction opposite to the direction of the second member 34. Such third member 40 is preferably provided with a pair of portions 42 forming a V-shaped aperture (not shown) or a well known claw. The preferred material of such tool head 30 is metal and, more particularly, such metal is steel. Preferably, the striking end 36 is magnetized.

The second end 24 of the elongated member 20 is adapted to rigidly receive a means, generally designated 50, for removable attachment of various working elements 80. In the presently preferred embodiment, such means 50 includes a first member 52 secured in the second end 24 of the elongated member 20 and axially extending therefrom. The first member 52 has a collapsible open end 54 for receiving a holding portion 82 of the working element 80. A nut-like second member 56 threadably engages the outer surface of the first member 52 in a manner that a rotation of such second member 56 in one direction partially collapses the open end 54 thus securing the holding portion 82 of such working element 80 and a rotation of such second member 56 in the opposite direction enables expansion of the open end 54 and removal of such working element 80. Preferably, the outer surface of the second member 56 is provided with serrations 58 to aid in gripping.

Alternatively, as best shown in FIGS. 3 and 4a, such means 50 may include a first member 60 secured in the second end 24 and having a cavity 62 of a predetermined shape disposed adjacent an open end of such first member 60 and at least one means 94 engageable with the cavity 62 for frictionally securing one end of such working element 80 therein. Preferably, such means 94 is a well-known spring loaded ball 94.

Alternatively, such means 50 may comprise a well known drill chuck (not shown).

The combination hand tool 10 may be provided with means 70 disposed within a first predetermined portion of an outer surface of such elongated member 20 intermediate the ends thereof for frictionally and removably retaining at least one working element 80. In the presently preferred embodiment of the invention, such means 70 is at least one and preferably, a predetermined plurality of tab portions 72 formed integral to the elongated member 20 and disposed in pairs to form an aperture 74 of a second predetermined shape for frictionally receiving at least a holding portion 82 of the working element 80. It will be appreciated that such tab portions 72 provide for ease of insertion and removal of such at least one working element 80.

Examples of working elements 80 usable with such combination hand tool 10 is best shown in FIGS. 4a-4c. Each working element 80 is formed by the holding portion 82, generally being elongated, and a working portion 84 which can be selected to perform a predetermined function. For example, FIG. 4a shows a working element 80 with the working portion 84 configured as an adjustable spanner having a fixed jaw 86 and a movable jaw 88. FIG. 4b shows another example of the working element 80, wherein the working portion 84 is configured with a screw driver type head 90 suitable for cooperation with fasteners (not shown) having a slotted type head (not shown). FIG. 4c shows yet another example of the working element 80, wherein the working portion 84 is configured with an end 92 suitable for cooperation with the fasteners (not shown) having a Phillips type head (not shown). Advantageously, such combination of working elements 80 has been found sufficient to perform a variety of basic functions.

The elongated member 20 may be further adapted with an aperture 100 disposed intermediate the ends thereof for removable retainment of a measuring tape assembly 102 having a measuring tape 104 disposed within a case 106. The means 108 pivotally attached to the outer surface of the elongated member 20 adjacent one open end of such aperture 100 may be provided to pivot into the aperture 100 and at least partially move the measuring tape assembly 102 outwardly from the aperture 100 enabling full removal of the measuring tape assembly 102 for use. Means 109, preferably at least one tab 109, extending into such aperture 100 and engaging the case 106 may be provided for frictionally retaining the measuring tape assembly 102 within the aperture 100.

Advantageously, such embodiments enable use of any commercially available measuring tape assembly 102 having a case 106 suitable for insertion into the aperture 100 and therefore enable economic and efficient replacement of such measuring tape assembly 102 when required. Additionally such measuring tape assembly 102 can be easily inserted into and removed from such aperture 100. It will be appreciated that the measuring tape assembly 102 can be used independently from the combination hand tool 10 providing for ease of dimensional measurement.

A leveling means, generally designated 110, includes at least one bubble-type level 112 disposed within a second predetermined portion of the elongated member 20. Preferably, such leveling means 110 is a pair of bubble-type levels 112 and 114 with the first level 112 disposed for level measurement in a horizontal plane and the second level 114 disposed for level measurement in a vertical plane.

When precision is required in level measurements, the combination hand tool 10 may be provided with a level reference means, generally designated 120, and best shown in FIGS. 1 and 2, which in the preferred embodiment comprises a first surface portion 122 disposed on the elongated member 20, preferably adjacent the second end 24, and a second surface portion 124 disposed on the tool head 30, preferably integral to the first member 32. With a particular reference to FIG. 2, the first surface portion 122 and the second surface portion 124 are raised about the elongated member 20 and the tool head 30 respectively to define a planar surface 126 which is disposed beyond the means 70 and working elements 80 so as to eliminate impact thereof onto level measurements.

Although the present invention has been described in terms of a tool head having a combination of the flat striking end and the claw-type end suitable for removal of nails and other fasteners, it will be apparent to those skilled in the art, that the present invention may be applied to other tool head types. For example, either the striking end or the claw-type end may be formed as a partial sphere.

Furthermore, the material of such tool head 30 may be any rigid material suitable to withstand impact loads.

Additionally, the retainment means 70 may be separately formed and rigidly attached to the elongated member 20. For example, a narrow strip having pairs of tabs affixed thereto will be sufficient to retain working elements 80. Such embodiment will be advantageous when the elongated member 20 is manufactured from a wood material to provide for reliable retainment of the working elements 80 and reduce overall cost of the combination tool 10.

The retainment of the measuring tape assembly 102 may be provided by a member pivotally attached to the outer surface of the elongated member 20 adjacent the other open end of such aperture 100 for at least partially covering such second end and retaining the measuring tape assembly 102. Alternatively, the at least one tab 109 can be provided on the outer surface of the case 106 of the measuring tape 102.

The measuring tape assembly 102 may also be provided with a retaining frame which is rigidly attached within the aperture 100 which will be advantageous when the material of the elongated member 20 is wood.

It will be apparent to those skilled in the art that the measuring tape assembly of the resent invention may be removably attached to the outer surface of such elongated member by employing a retaining member integrally formed within the elongated member or rigidly attached thereto.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A combination hand tool comprising:
(a) an elongated member having a first predetermined shape and having a first end and an axially opposed second end;
(b) a tool head having a first portion for rigid attachment to said first end of said elongated member, a second portion outwardly extending from said first portion and terminated with a first end and a third portion outwardly extending from said first portion in a direction opposite to said second portion and terminated with a second end; and
(c) means rigidly disposed within said second end of said elongated member and axially extending therefrom for removable attachment of at least one working element.

2. The combination hand tool, according to claim 1, wherein a material of said elongated member is selected from wood, metal, engineered polymers and any combination thereof.

3. The combination hand tool, according to claim 1, wherein said combination hand tool further includes means engageable with said elongated member adjacent said second end thereof for gripping said combination hand tool during use.

4. The combination hand tool, according to claim 1, wherein said means for removable attachment of said at least one working element includes a first member secured in a cavity disposed within said second end and axially extending therefrom, said first member having a collapsible open end for receiving a holding portion of said at least one working element, and a nut-like second member threadably engaging an outer surface of said first member, whereby rotation of said second member in a first direction causes a partial collapse of said open end for securing said holding portion of said at least one working element, and whereby rotation of said second member in a second direction opposite to said first direction causes expansion of said open end and enables removal of said at least one working element.

5. The combination hand tool, according to claim 4, wherein an outer surface of said second member is serrated.

6. The combination hand tool, according to claim 1, wherein said means for removable attachment of said at least one working element includes a first member secured in a cavity disposed within said second end and axially extending therefrom, said first member having a cavity of a second predetermined shape disposed adjacent an open end thereof and means disposed within one of said cavity of said open end and said working element for frictionally and removeably securing said at least one working element.

7. The combination hand tool, according to claim 1, wherein said combination hand tool further includes means disposed within a first predetermined portion of an outer surface of said elongated member intermediate said first end and said second end thereof for frictional and removable retainment of said at least one working element.

8. The combination hand tool, according to claim 7, wherein said means for frictional and removable retainment of said at least one working element includes a predetermined plurality of tab portions engageable with said outer surface of said elongated member and disposed in pairs, each of said pair of said tab portions forming an aperture having a third predetermined shape for frictionally receiving at least a holding portion of said at least one working element.

9. The combination hand tool according to claim 1, wherein said combination hand tool further includes said at least one working element removably attached to said elongated member, said at least one working element having a predetermined working portion and an opposed holding portion.

10. The combination hand tool, according to claim 1, wherein said combination hand tool further includes a measuring tape assembly removably disposed within an aperture of said elongated member.

11. The combination hand tool, according to claim 10, wherein said combination hand tool further includes means pivotally attached to said outer surface of said elongated member adjacent one open end of said aperture, said means pivotable into said aperture for at least partially moving said measuring tape assembly outwardly from said aperture.

12. The combination hand tool, according to claim 10, wherein said combination hand tool further includes means engageable with one of said aperture, said outer surface of said elongated member, said measuring tape assembly and any combination thereof for frictionally retaining said measuring tape assembly within said aperture.

13. The combination hand tool, according to claim 10, wherein said measuring tape assembly further includes a case.

14. The combination hand tool, according to claim 1, wherein said combination hand tool further includes means engageable with one of said elongated member, said tool head and a combination thereof for performing at least one level measurement.

15. The combination hand tool, according to claim 14, wherein said means for performing at least one level measurement includes at least one bubble-type level.

16. The combination hand tool, according to claim 14, wherein said means for performing at least one level measurement includes at least one bubble-type level, a first surface portion disposed on said elongated member and a second surface portion disposed on said first portion of said tool head, wherein said first surface portion and said second surface portion form a reference plane for performing said at least one level measurement.

17. A combination hand tool comprising:
(a) an elongated member having a first predetermined shape and having a first end and an axially opposed second end;
(b) a tool head having a first portion for rigid attachment to said first end of said elongated member, a second portion outwardly extending from said first portion and terminated with a first end and a third portion outwardly extending from said first portion in a direction opposite to said second portion and terminated with a second end; and
(c) means engageable with said elongated member and said tool head for performing at least one level measurement, said means includes at least one bubble-type level, a first surface portion disposed within said elongated member and a second surface portion disposed within said first portion of said tool head, wherein said first surface portion and said second surface portion form a reference base plane for performing said at least one level measurement.

18. A combination hand tool comprising:
(a) an elongated member having a first predetermined shape and having a first end and an axially opposed second end;
(b) a tool head having a first portion for rigid attachment to said first end of said elongated member, a second portion outwardly extending from said first portion and terminated with a first end and a third portion outwardly extending from said first portion in a direction opposite to said second portion and terminated with a second end; and
(c) means disposed within a predetermined portion of said elongated member intermediate said first end and said second end thereof for removably retaining a measuring tape assembly, said measuring tape assembly having a measuring tape disposed within a case, said measuring tape assembly is fully removable for performing at least one measurement.

19. The combination hand tool, according to claim 18, wherein said means for removably retaining a measuring tape assembly is an aperture forming a first open end and an opposed second open end.

20. The combination hand tool, according to claim 18, wherein said means for removably retaining a measuring tape assembly is a retaining member integrally formed within said outer surface of said elongated member or rigidly attached thereto.
